(19) United States
(12) Patent Application Publication
(10) Pub. No.: US 2026/0307284 A1
(43) Pub. Date: Oct. 8, 2026

(54) TETHERING CORD ASSEMBLY WITH REMOVABLE LOCKING PIN FOR SECURING A SHEATH TO A BLADE

(71) Applicant: Ember Crafts LLC, Brooklyn, NY (US)

(72) Inventor: Jeffrey HO, Brooklyn, NY (US)

(21) Appl. No.: 19/172,083

(22) Filed: Apr. 7, 2025

(51) Int. Cl. B26B 29/02

(52) U.S. Cl. CPC B26B 29/025

(57) ABSTRACT

A tethering cord assembly for securing a sheath to a blade. The tethering cord assembly may comprise a sheath, where the sheath is sized and shaped to cover the blade, and where the sheath comprises a pin hole for receiving a removable locking pin. The assembly may further comprise a tethering cord, where a proximal end of the tethering cord is affixed to the sheath, where a distal end of the tethering cord is affixed to the removable locking pin, and where the tethering cord is configured to secure the sheath to the blade upon insertion of the removable locking pin into the pin hole.

### FIELD OF THE DISCLOSURE

The present disclosure relates generally to a tethering cord assembly, and more particularly, to a mechanism to prevent unintended removal or loss of a removable locking pin when securing a sheath to a blade. The sheath may include a traditional Japanese chef’s knife cover known as a “Saya.”

### BACKGROUND

A sheath is traditionally used to cover a blade, such as but not limited to a knife. A traditional Japanese chef’s knife sheath known as a “Saya” may include a removable locking pin. This removable locking pin may be inserted into a pin hole on the sheath, thereby affixing the sheath to the blade.

However, it is common for the removable locking pin to be lost, requiring constant monitoring of the pin’s location or a need for a replacement. Moreover, in some designs, this locking pin can be quite small, requiring storage in a safe location when the blade is in use.

Accordingly, what is needed is a mechanism to secure a removable locking pin to a sheath so that this removable locking pin is not at risk of loss.

### SUMMARY

An object of the present disclosure is to provide a mechanism for securing a removable locking pin to a sheath.

In one exemplary embodiment according to the present disclosure, a tethering cord assembly for securing a sheath to a blade is provided. In some aspects, the tethering cord assembly comprises a sheath, where the sheath is sized and shaped to cover the blade, and where the sheath comprises a pin hole for receiving a removable locking pin. The assembly may further comprise a tethering cord, where a proximal end of the tethering cord is affixed to the sheath, where a distal end of the tethering cord is affixed to the removable locking pin, and where the tethering cord is configured to secure the sheath to the blade upon insertion of the removable locking pin into the pin hole.

In some embodiments, the tethering cord assembly comprises an embedding plug. The embedding plug may affix the proximal end of the tethering cord to the sheath via an embedding plug hole. In these embodiments, the proximal end of the tethering cord may be insertable into the embedding plug hole, with the embedding plug insertable thereafter to affix the tethering cord to the sheath.

In some embodiments, the removable locking pin comprises a channel configured to receive the tethering cord. The distal end of the tethering cord may further comprise a stopper, where a diameter of the stopper exceeds a diameter of the channel, thereby securing the tethering cord within the channel.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings.

FIG. 1 is a front facing view of a non-limiting embodiment of the tethering cord assembly of the present disclosure.

FIG. 2 is a top view a non-limiting embodiment of the tethering cord assembly of the present disclosure.

FIG. 3 is a top perspective view of a non-limiting embodiment of the tethering cord assembly of the present disclosure.

FIGS. 4A-4D depict non-limiting examples of alternative mechanisms for securing a tethering cord to a sheath to form the tethering cord assembly of the present disclosure.

FIG. 5 depicts an example mechanism for inserting a blade into a sheath of the tethering cord assembly to establish an unlocked position.

FIG. 6 depicts a non-limiting embodiment of the tethering cord assembly of the present disclosure in a locked position securing a blade.

### DETAILED DESCRIPTION

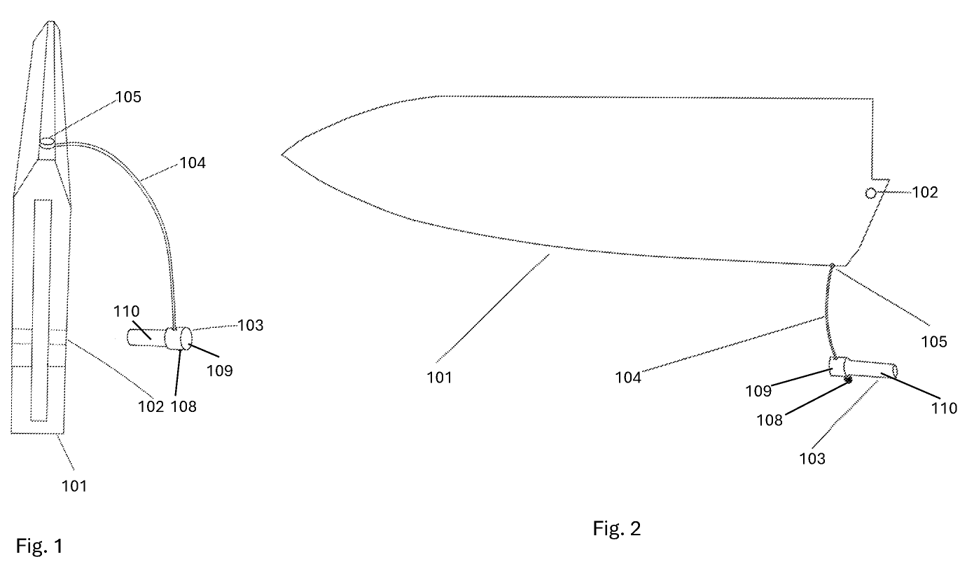

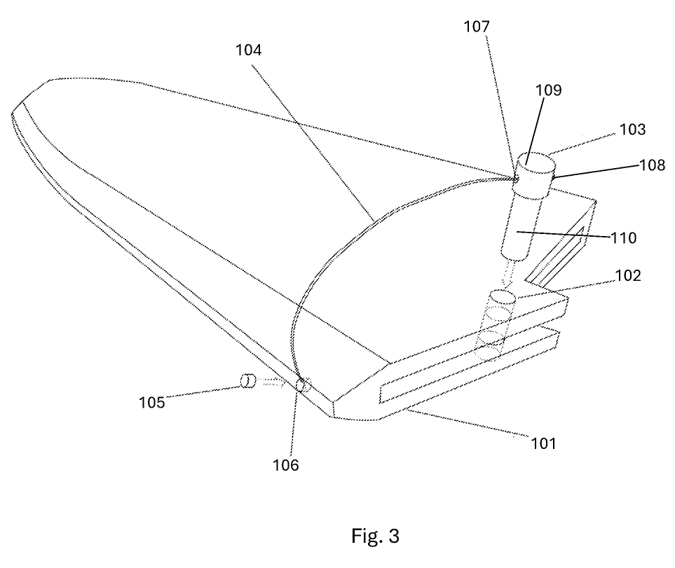

FIGS. 1-6 depict a tethering cord assembly of the present disclosure. The tethering cord assembly may secure a sheath 101 to a blade 100. The sheath 101 may include any material, without particular limitation, such as, but not limited to, wood, leather, metal, ceramic, plastic, or any combination thereof. In some non-limiting examples, the sheath 101 may comprise a traditional Japanese chef’s knife cover known as a “Saya.” The blade 100 may be any type of blade, such as but not limited to a knife, a sword, any other suitable blade type, or any combination thereof. The sheath 101 may be appropriately sized and shaped to cover the blade 100.

As shown in FIGS. 1-3, the sheath 101 may comprise a pin hole 102 for receiving a removable locking pin 103. In certain examples, the removable locking pin 103 has a head portion 109 and a shaft 110. The head portion 109 may have a larger diameter than the shaft 110. The shaft 110 may be insertable into the pin hole 102 of the sheath 101, with the head portion 109 securing the removable locking pin 103 in place.

As further shown in FIGS. 1-3, the assembly may further comprise a tethering cord 104 that is configured to secure the sheath 101 to the blade upon insertion of the removable locking pin 103 into the pin hole 102. The tethering cord 104 may have a distal end and a proximal end. As defined herein, the distal end of the tethering cord 104 is a portion of the tethering cord 104 that is adjacent to the pin hole 102 while the assembly is in a locked position, whereas the proximal end of the tethering cord 104 is defined as a portion that is affixed to the sheath 101.

As further depicted in FIGS. 1-3, in some examples, a distal end of the tethering cord 104 may be secured to the removable locking pin 103 within a channel 107. The channel 107, which may be present within the head portion 109 of the removable locking pin 103, may be configured to receive the tethering cord 104. In certain embodiments, the distal end of the tethering cord 104 further comprises a stopper 108. This stopper 108 can be any mechanism where a diameter of the stopper 108 exceeds a diameter of the channel 107, thereby securing or affixing the tethering cord 104 within the channel 107 or otherwise presenting removal of the tethering cord 104 from the channel 107. In certain aspects, the stopper 108 comprises a knot, an end cap, an adhesive, a protrusion, any other mechanism that prevents removal of the tethering cord 104 from the channel 107, or any combination thereof.

In some non-limiting embodiments, the assembly comprises an embedding plug 105. In these embodiments, the proximal end of the tethering cord 104 may be affixed to the sheath by the embedding plug 105. The assembly may further comprise an embedding plug hole 106 for affixing the embedding plug 105 and the tethering cord 104 to the sheath 101. Specifically, while the assembly is being put together, the proximal end of the tethering cord 104 may be insertable into the embedding plug hole 106. The embedding plug 105 may then be insertable thereafter, affixing the tethering cord 104 to the sheath 101.

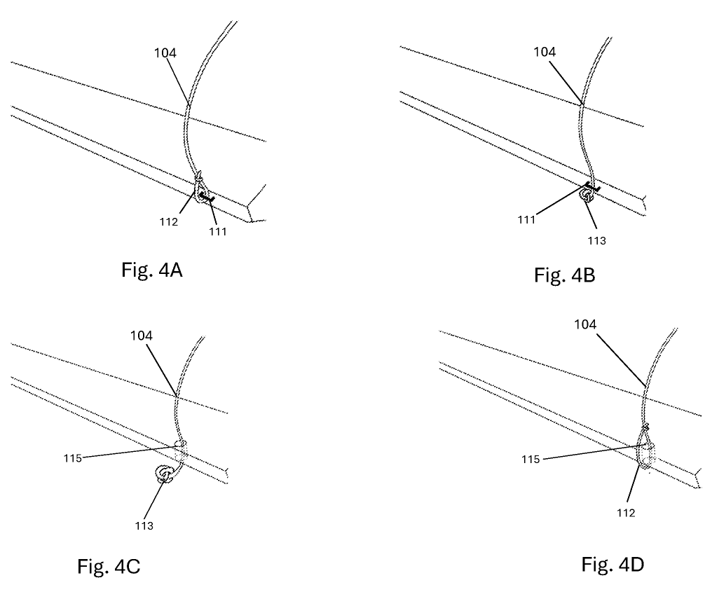

As shown in FIGS. 4A-4D, the proximal end of the tethering cord 104 may be secured to the sheath 101 by an alternative mechanism to the embedding plug 105, the embedding plug hole 106, or a combination thereof. For instance, in one embodiment shown in FIG. 4A, the proximal end of the tethering cord 104 may be secured to a fastener 111—including but not limited to a staple—by a loop 112. In another embodiment shown in FIG. 4B, the proximal end of the tethering cord 104 may be secured to the fastener 111 by a stopper 113. This stopper 113 may include any mechanism that prevents removal of the tethering cord 104 from the fastener 111, including, but not limited to, any mechanism or combination thereof described above with reference to stopper 108. In a further embodiment shown in FIG. 4C, the stopper 113 may secure the proximal end of the tethering cord 104 within a channel 115. In yet another embodiment, shown in FIG. 4D, the proximal end of the tethering cord 104 may be secured via the loop 112 to the channel 115 or another suitable opening. The embodiments depicted in FIGS. 4A-4D are not intended to be limiting and other mechanisms for securing the proximal end of the tethering cord 104 to the sheath 101 may be employed. For instance, in further embodiments, the proximal end of the tethering cord 104 may be secured to the sheath 101 by a nail or a screw, secured via an adhesive, or any combination thereof.

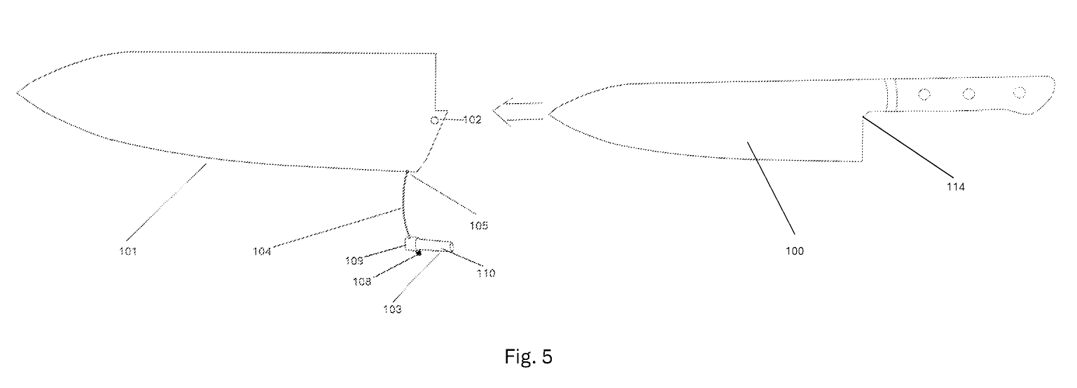

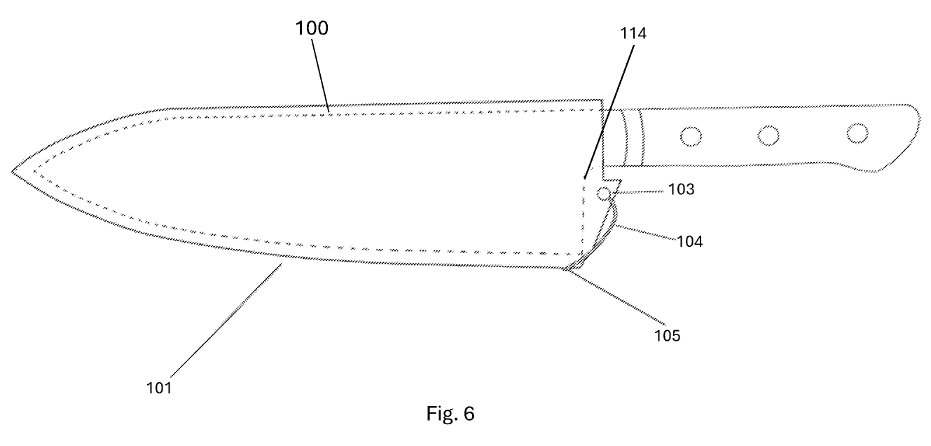

In some aspects, the embedding plug 105 is not removable during operation of the tethering cord assembly. As defined herein, “operation” means the use of the assembly to secure or remove the sheath 101 to or from the blade 100. “Operation” would not include instances where the assembly is being put together. Accordingly, during operation, the tethering cord 104 remains secured to the sheath 101 (e.g., within the embedding plug hole 106 by the embedding plug 105), allowing the removable locking pin 103 to be inserted or removed from the pin hole 102 to transition the assembly between locked and unlocked positions as shown in FIGS. 5-6.

During operation, the blade 100 may be inserted into the sheath 101 of the present tethering cord assembly, as shown in FIG. 5, to establish an unlocked position. As shown in FIG. 6, the sheath 101 may then be secured to the blade by placing the removable locking pin 103 in the pin hole 102. The pin hole 102 may be located adjacent to a heel 114 of the blade 100, with a position of the shaft 110 of the removable locking pin 103 orthogonally abutting the heel 114, securing the sheath 101 in place. In this locked position, the tethering cord 104 would ensure that the removable locking pin 103 remains in place within the pin hole 102. When a user would like to use the blade 100, the removable locking pin 103 would be removed from the pin hole 102 reverting the assembly back to the unlocked position shown in FIG. 5. In this unlocked position, the blade 100 can be removed from the sheath 101 with the removable locking pin 103 remaining attached to the sheath 101 by the tethering cord 104 (e.g., via the embedding plug 105, the embedding plug hole 106, and the channel 10— or by another mechanism, such as, but not limited to those described in FIGS. 4A-4C). Thus, the tethering cord 104 ensures that the removable locking pin 103 is affixed to the sheath 101 in both the locked and unlocked positions. ss

In embodiments with an embedding plug hole 106, the embedding plug hole 106 may be spaced a sufficient distance from the pin hole 102 to allow the tethering cord 104 to secure the sheath 101 to the blade 100 by permitting insertion of the removable locking pin 103 within the pin hole 102. This sufficient distance is not particularly limited as long as the distance permits insertion of the removable locking pin 103 within the pin hole 102 and does not cause detachment of the proximal end of the tethering cord 104 from the sheath 101. The sufficient distance may depend on the geometry or size of the sheath 101. In some embodiments, the embedding plug hole 106 may be moved to various locations along the sheath 101 as long as these locations permit insertion of the removable locking pin 103 within the pin hole 102 and does not cause detachment of the proximal end of the tethering cord 104 from the sheath 101. In particular variations, the tethering cord may be lengthened or shortened accordingly to accommodate movement to these various locations.

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure.

As shown throughout the drawings, like reference numerals designate like or corresponding parts. While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

1. A tethering cord assembly for securing a sheath to a blade, the assembly comprising:
a sheath, where the sheath is sized and shaped to cover the blade, and where the sheath comprises a pin hole for receiving a removable locking pin; and
a tethering cord, where a proximal end of the tethering cord is affixed to the sheath, where a distal end of the tethering cord is affixed to the removable locking pin, and where the tethering cord is configured to secure the sheath to the blade upon insertion of the removable locking pin into the pin hole.

2. The tethering cord assembly of claim 1, further comprising an embedding plug wherein the embedding plug is adapted to affix the proximal end of the tethering cord to the sheath.

3. The tethering cord assembly of claim 2, where the sheath further comprises an embedding plug hole, where the proximal end of the tethering cord is insertable into the embedding plug hole, with the embedding plug insertable thereafter to affix the tethering cord to the sheath.

4. The tethering cord assembly of claim 2, where the embedding plug is not removable during operation of the tethering cord assembly.

5. The tethering cord assembly of claim 1, where the removable locking pin comprises a channel, where the channel is configured to receive the tethering cord.

6. The tethering cord assembly of claim 5, where the distal end of the tethering cord further comprises a stopper, where a diameter of the stopper exceeds a diameter of the channel, thereby securing the tethering cord within the channel.

7. The tethering cord assembly of claim 6, where the stopper comprises a knot, an end cap, or any combination thereof.

8. The tethering cord assembly of claim 5, where the removable locking pin has a head portion and a shaft, where the head portion has a larger diameter than the shaft, and where the shaft is insertable into the pin hole of the sheath, with the head portion securing the removable locking pin in place.

9. The tethering cord assembly of claim 3, where the embedding plug hole is spaced a sufficient distance from the pin hole to allow the tethering cord to secure the sheath to the blade.

10. A tethering cord assembly for securing a sheath to a blade, the assembly comprising:
a sheath, where the sheath is sized and shaped to cover the blade, and where the sheath comprises:
a pin hole for receiving a removable locking pin, and
an embedding plug hole, where a proximal end of a tethering cord is insertable into the embedding plug hole, with an embedding plug insertable thereafter;
the removable locking pin, where the removable locking pin comprises:
a head portion, where the head portion comprises a channel configured to receive the tethering cord, and
a shaft, where the shaft is insertable within the pin hole; and
the tethering cord, where the tethering cord comprises a stopper,
where a proximal end of the tethering cord is affixed to the sheath via the embedding plug and the embedding plug hole,
where the stopper is at a distal end of the tethering cord and the stopper affixes the tethering cord within the channel of the removable locking pin, and
where the tethering cord is configured to secure the sheath to the blade upon insertion of the removable locking pin into the pin hole.
